(19) United States
(12) Patent Application Publication
(10) Pub. No.: US 2008/0217488 A1
(43) Pub. Date: Sep. 11, 2008

(54) Device for Retaining at Least One Elongate Object

(75) Inventor: Frederic Carretero, Grenoble (FR)

Correspondence Address: BAKER & DANIELS LLP;111 E. WAYNE STREET, SUITE 800, FORT WAYNE, IN, 46802, US

(73) Assignee: A. RAYMOND ET CIE, Grenoble (FR)

(21) Appl. No.: 11/916,223

(22) PCT Filed: Apr. 5, 2006
(86) PCT No.: PCT/EP06/03067

§ 371 Date: Dec. 3, 2007

(30) Foreign Application Priority Data
Jun. 3, 2005 (DE) 10 2005 025 679.1

(51) Int. Cl. F16L 3/00

(52) U.S. Cl. 248/65

(57) ABSTRACT

A device for retaining at least one elongate object has at least one base-side wall portion (4, 9), mutually opposite lateral wall portions (5, 10), and at least one resilient cover portion (6, 11) located opposite the or each base-side wall portion (4, 9), the wall portions (4, 5, 9, 10) and the or each cover portion (6, 9) enclosing a receiving space (7). Attached to at least one cover portion (6, 11) is a first end of a connecting portion (8, 12) that extends within the receiving space (7) and has a second end attached to one of the wall portions (4, 5, 9, 10). Thus, only a small amount of space is required for the object to be retained reliably when subjected to a given pull-out force.

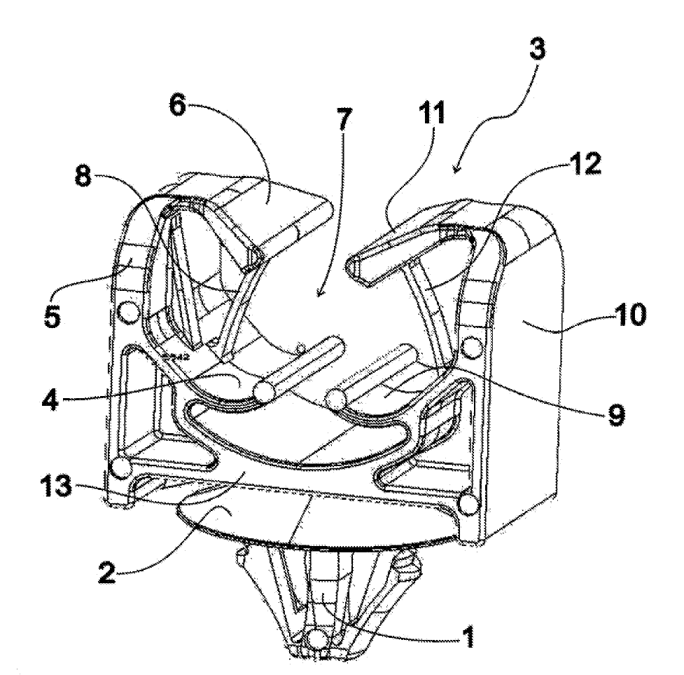

### BACKGROUND OF THE INVENTION

1. Field of the Invention

The invention concerns a device for retaining at least one elongate object. The device comprises at least one base-side wall portion, mutually opposite lateral wall portions, and at least one resilient cover portion located opposite the or each base-side wall portion, wherein the wall portions and the or each cover portion are disposed marginally to a receiving space.

2. Description of the Related Art

A device of this type is known, for example, from DE 196 34 309 A1. In the prior device, a base-side wall portion, two mutually opposite lateral wall portions, and two resilient cover portions each of which is attached to a respective wall portion enclose a receiving space into which a conduit line, as an elongate object, can be inserted. The cover portions are bent in the direction of the receiving space and bear with their terminating ends against an inserted conduit line, which is thereby retained. The bending brings about adequate securement for many applications.

### SUMMARY OF THE INVENTION

The object underlying the invention is to provide a retention device that is distinguished by small space consumption.

This object is achieved according to the invention by the fact that attached to at least one cover portion is a first end of a connecting portion that extends within the receiving space and has a second end attached to one of the wall portions.

By the provision of a connecting portion according to the invention, the or each cover portion to which a connecting portion is attached keeps deflecting unhindered in the insertion direction during the insertion of an object to be retained, whereas when the or each connecting portion moves oppositely to the insertion direction, the cover portion connected to it is prevented from moving out of the receiving space, within the limits of the tensile strength and strength of connection of the connecting portion, with the result that very low space consumption is obtained in combination with a given retaining force.

For especially secure retention of an object in combination with low space consumption, two cover portions are present, each of which has a respective cover portion attached to it.

For reasons of strength, it is further advantageous for the second end of the or each cover portion to be attached in the region of transition between a base-side wall portion and a lateral wall portion.

For high stability, it is advantageous for the second end of the or each cover portion to be attached in the region of transition between a base-side wall portion and a lateral wall portion.

To ensure the unhindered insertion of an object, it is usefully provided that the or each connecting portion is so contrived as to move in the direction of the lateral wall portion thereadjacent when the or each cover portion deflects into the receiving space.

Further useful configurations and advantages will emerge from the following description of a preferred exemplary embodiment of the invention, taken with reference to the sole FIGURE of the drawing.

### BRIEF DESCRIPTION OF THE DRAWING

The above mentioned and other features and objects of this invention, and the manner of attaining them, will become more apparent and the invention itself will be better understood by reference to the following description of an embodiment of the invention taken in conjunction with the accompanying drawing, wherein:

The FIGURE shows an exemplary embodiment, made of plastic, of the inventive device for retaining an elongate object (not shown in the FIGURE) on a base part (also not shown in the FIGURE), for example the body of a motor vehicle. The illustrated and described exemplary embodiment is provided with an anchor foot 1 that is known per se and a cover plate 2 for concealing a recess provided in the base part and into which the anchor foot 1 can be inserted

Corresponding reference characters indicate corresponding parts throughout the several views. Although the exemplification set out herein illustrates one embodiment of the invention, the embodiment disclosed below is not intended to be exhaustive or to be construed as limiting the scope of the invention to the precise form disclosed.

### DETAILED DESCRIPTION

Disposed on the opposite side of the cover plate 2 from the anchor foot 1 is a tube retainer 3 for retaining a tube, as an example of an elongate object. The tube retainer 3 is provided with a resilient first base-side wall portion 4, a stiffened first lateral wall portion 5 and a resilient first cover portion 6, which are connected to one another and are disposed on one side of a receiving space 7.

Attached in the edge region of first cover portion 6 directed away from first lateral wall portion 5 is a first end of an elastically bendable first connecting portion 8, which extends within receiving space 7 and whose second end, in the illustrated exemplary embodiment, is attached in the region of transition between first base-side wall portion 4 and first lateral wall portion 5.

The tube retainer 3 is further provided with a resilient second base-side wall portion 9, a stiffened second lateral wall portion 10 and a resilient second cover portion 11, which are connected to one another and are disposed on the other side of the receiving space 7.

Attached in the edge region of first [sic] cover portion 11 directed away from second lateral wall portion 10 is a first end of an elastically bendable second connecting portion 12, which extends within receiving space 7 and whose second end, in the illustrated exemplary embodiment, is attached in the region of transition between second base-side wall portion 9 and second lateral wall portion 10.

Two ends of a connecting structure 13 disposed oppositely from the two ends of connecting portions 8, 12 are formed on in the regions of transition between base-side wall portions 4, 9 and lateral wall portions 5, 10, and brace the wall portions 4, 5, 9, 10 against foot part 1.

The ends of resilient cover portions 6, 11 directed away from lateral wall portions 5, are arranged in spaced-apart relation and leave a gap for insertion of the elongate object that is to be retained. In addition, the ends of resilient cover portions 6, 11 directed away from the respective lateral wall portions 5, 10 are bent in the direction of base-side wall portions 4, 9 and thereby form a funnel to guide the elongate object.

Connecting portions 8, 12 are bowed slightly in the direction of their respective adjacent lateral wall portions 5, 10, so that they bend when cover portions 6, 11 deflect in the direction of said adjacent lateral wall portions 5, 10 and do not hinder the insertion of the object into receiving space 7. On completion of the insertion process, during which base-side wall portions 4, 9 also deflect in the direction of connecting structure 13 to a degree that depends on the dimensions of the object, once the connecting portions 8, 11 have at least partially relaxed, the free terminating faces of cover portions 6, 11 bear against the object.

Accidental movement of the object out of receiving space 7 against the direction of insertion is henceforth reliably prevented even under high loads—within the limits of the tensile strength of connecting portions 8, 12 and the strength of the connection of the ends of connecting portions 8, 12—with minimal space consumption. To remove the object, however, it is still possible to move cover portions 6, 11 in the direction of wall portions 4, 9 and thereby release the retained object for removal.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-4. (canceled)

5. A retention device for retaining an elongate object, said device comprising two base-side wall portions, two mutually opposed lateral wall portions, a resilient cover portion located opposite one said base-side wall portion, said base-side wall portions, said lateral wall portions and said cover portion defining a receiving space; a connecting portion attached to each said respective cover portions, a first end of each respective connecting portion extending within said receiving space, and a second end of each respective connecting portion attached in the region of transition which is located between a said base-side wall portion and a said lateral wall portion; a connecting structure formed onto said regions of transition between said base-side wall portions and said lateral wall portions, opposite said second ends of said connecting portions; a foot part, said connecting structure bracing said base-side wall portions and said lateral wall portions against said foot part, said base-side wall portions adapted to deflect resiliently in the direction of said connecting structure.

6. The device as in claim 5 having two said cover portions, each respective cover portion attached to a respective connecting portion.

7. The device of claim 5 wherein said first end of each respective connecting portion is attached to the outer edge region of a respective cover portion.

8. The device of claim 5 wherein each said connecting portion is movable in the direction of the said wall portion thereadjacent when said associated cover portion deflects into said receiving space.
